(19) United States
(12) Patent Application Publication
(10) Pub. No.: US 2014/0056446 A1
(43) Pub. Date: Feb. 27, 2014

(54) Micro-Speaker

(71) Applicants: Lin-Zhen Li, Shenzhen (CN); Xiong Zhang, Shenzhen (CN)

(72) Inventors: Lin-Zhen Li, Shenzhen (CN); Xiong Zhang, Shenzhen (CN)

(73) Assignees: AAC MICROTECH(CHANGZHOU) CO., LTD., Changzhou (CN); AAC ACOUSTIC TECHNOLOGIES (SHENZHEN) CO., LTD., Shenzhen (CN)

(21) Appl. No.: 14/010,620

(22) Filed: Aug. 27, 2013

(30) Foreign Application Priority Data
Aug. 27, 2012 (CN) 201220428095.3
Aug. 27, 2012 (CN) 201220429847.8

(51) Int. Cl. H04R 1/00

(52) U.S. Cl. CPC H04R 1/00
USPC 381/162

(57) ABSTRACT

A micro-speaker includes a vibrating unit including a diaphragm and a voice coil, and a magnetic circuit unit supporting the diaphragm. The diaphragm includes a position portion serving as an edge of the diaphragm. The magnetic circuit unit includes a base board, a first magnetic conduction member disposed at a central portion of the base board, a second magnetic conduction member around the first magnetic conduction member, and a magnetic gap formed by the first and second magnetic conduction members. A projection of the diaphragm along the vibration direction on the base board is within an outline of the base board. The micro-speaker has no frame or any structure with a frame configuration, which makes the magnetic circuit unit enlarge for providing improved performance.

### FIELD OF THE DISCLOSURE

The present disclosure relates to the art of speakers, particularly to a micro-speaker used in an electronic device.

### DESCRIPTION OF RELATED ART

Micro-speakers have been widely used in portable electronic devices, such as cellular phones, notebooks, and so on. With the continuing development of the portable electronic devices, people request for more and more functions with audible sensations, which brings a rapid development of the technologies of micro-speakers.

A related micro-speaker includes a frame, a vibrating unit and a magnetic circuit unit attached to the frame. The vibrating unit includes a diaphragm attached to the frame. The magnetic circuit unit includes a yoke positioned to the frame and a magnet disposed in the yoke.

The frame is used to accommodate the magnetic circuit unit and support the diaphragm. However, the frame of the related micro-speaker takes a lot of space, which makes the magnetic circuit unit have a small size and the micro-speaker have a low sensitivity.

Therefore, it is desirable to provide a micro-speaker which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a micro-speaker in accordance with a first embodiment of the present disclosure.

FIG. 2 is an exploded view of the micro-speaker of FIG. 1.

FIG. 3 is a cross-sectional view of the micro-speaker taken along line III-III of FIG. 1.

FIG. 4 is a cross-sectional view of a micro-speaker in accordance with a second embodiment of the present disclosure.

FIG. 5 is a cross-sectional view of a magnetic circuit unit of a micro-speaker in accordance with the first embodiment of the present disclosure.

FIG. 6 is a cross-sectional view a magnetic circuit unit of a micro-speaker in accordance with a third embodiment of the present disclosure.

FIG. 7 is a cross-sectional view of a magnetic circuit unit of a micro-speaker in accordance with a fourth embodiment of the present disclosure.

### DETAILED DESCRIPTION OF THE EMBODIMENT

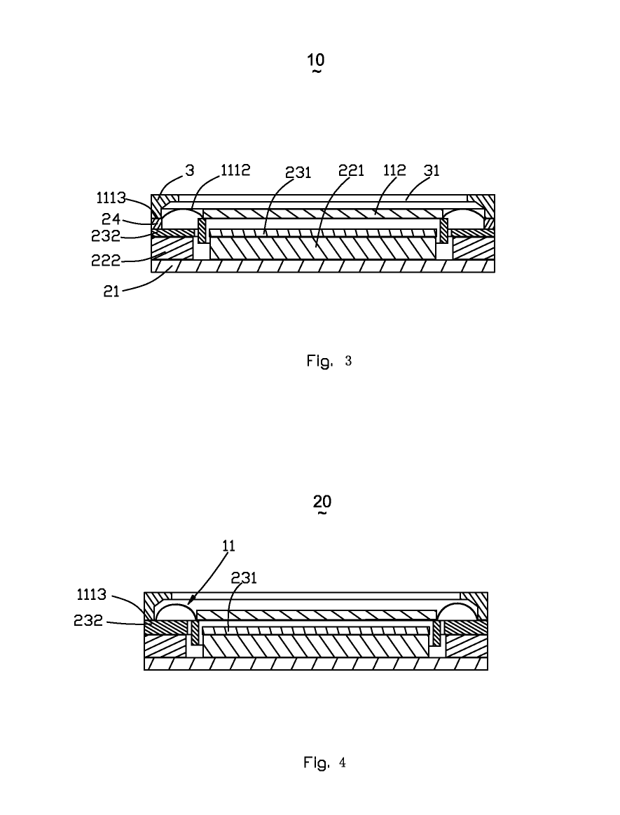

Referring to FIGS. 1-3, a micro-speaker 10 in accordance with a first embodiment of the present disclosure, includes a vibration unit 1 and a magnetic circuit unit 2. The vibration unit 1 includes a diaphragm 11 and a voice coil 12 capable of driving the diaphragm 11 to vibrate along a vibration direction. The diaphragm 11 includes a base film 111 and a top plate 112 attached on the base film 111. The base film 111 includes a flat central portion 1111, a curved portion 1112 extending from the central portion 1111 and surrounding around the top plate 112, and a position portion 1113 disposed at an edge of the base film 111. In other embodiment, the flat central portion 1111, or the top plate 112 of the diaphragm 11 could be omitted.

The magnetic circuit unit 2 includes a base board 21, a first magnetic conduction member 221 disposed at a center portion of the base board 21, a second magnetic conduction member 222 disposed at a periphery portion of the base board 21 for forming a magnetic gap with the first magnetic conduction member 221. At least one of the first and second magnetic conduction members 221,222 is a permanent magnet. In this embodiment, four separated second magnetic conduction members 222 are provided to surround the first magnetic conduction member 221. Each two adjacent second magnetic conduction members 222 forms a gap 223 therebetween. The gap 223 communicates with outside of the micro-speaker and serves as an air-leaking hole. In other embodiment, the amount of the second magnetic conduction members 222 is variable corresponding to actual requirements, and the second magnetic conduction member 222 may be an integrated ring-shaped configuration without gaps. The voice coil 12 has one end accommodated in the magnetic gap and the other end connected with the diaphragm 11. Optionally, the voice coil 12 may be connected to the diaphragm 11 via a medium which is directly connected with the diaphragm 11. In other words, the voice coil 12 may be connected to the diaphragm 11 directly or indirectly. Therefore, the term “connect” here means to connect something to another via a medium or to connect something to another directly without any medium.

The magnetic circuit unit is a necessary component or combination of a plurality of components used in an electro-acoustic device. The magnetic circuit unit is used to provide a closed loop of a magnetic field, and is formed by magnetic conduction materials. In this embodiment, the magnetic circuit unit 2 further includes a first pole plate 231 attached on a top face of the first magnetic conduction member 221 and a ring-shaped second pole plate 232 attached on top faces of the second magnetic conduction member 222. The shape of the second pole plate 232 is not restricted to the ring as described in this embodiment. Alternatively, the second pole plate 232 may be a rectangular plate corresponding to each of the second magnetic conduction members 222. While electrified, the voice coil 12 drives the diaphragm 11 to vibrate along a vibration direction by the interaction between the voice coil 12 and the magnetic circuit unit 2. Generally, the vibration direction is perpendicular to the base board 21.

A gasket 24 is attached on the second pole plate 232. The vibrating unit 1 is mounted to the magnetic circuit unit 2 with the position portion 1113 of the diaphragm 11 positioned on a top face of the gasket 24. The gasket 24 has a top face higher than the first pole plate 232 so that a greater vibration space is formed for the diaphragm 11. In fact, the gasket 24 is an optional element for increasing the vibration space of the diaphragm 11. It is also feasible that the diaphragm 11 is directly connected to the magnetic circuit unit 2 without the gasket 24, like the second embodiment which will be described in later paragraph. Again, the term “connect” here means to connect something to another via a medium or to connect something to another directly without any medium.

The curved portion 1112 of the diaphragm 11 is disposed above the second pole plate 232. A projection of the diaphragm 11 on the base board 21 along the vibration direction of the diaphragm 11 is within an outline of the base board 21. Compared with the related art, the diaphragm is supported by the magnetic circuit unit, and the voice coil is accommodated in the space formed by the diaphragm and the magnetic unit, which configuration omits the frame used in related art. In addition, if provided with a same size to the related art, the magnetic circuit unit could be enlarged for providing improved performance.

Optionally, the micro-speaker 10 further includes a front cover 3 attached to the vibrating unit 1 and the magnetic circuit unit 2. The front cover 3 has an acoustic hole 31 for emitting sounds generated by the diaphragm 11. In addition, the front cover 3 presses on the position portion 1113 of the diaphragm 11 for fixing the diaphragm 11 on the magnetic circuit unit 2.

Referring to FIG. 4, a micro-speaker 20 in accordance with a second embodiment of the present disclosure, has no gasket as described in the first embodiment. The position portion 1113 of the diaphragm 11 is positioned directly on the second pole plate 232. Optionally, the second pole plate 232 has a top face higher than that of the first pole plate 231 thereby providing a greater vibration space to the diaphragm 11. In fact, this embodiment provides a solution that the diaphragm 11 directly connects to the magnetic circuit unit.

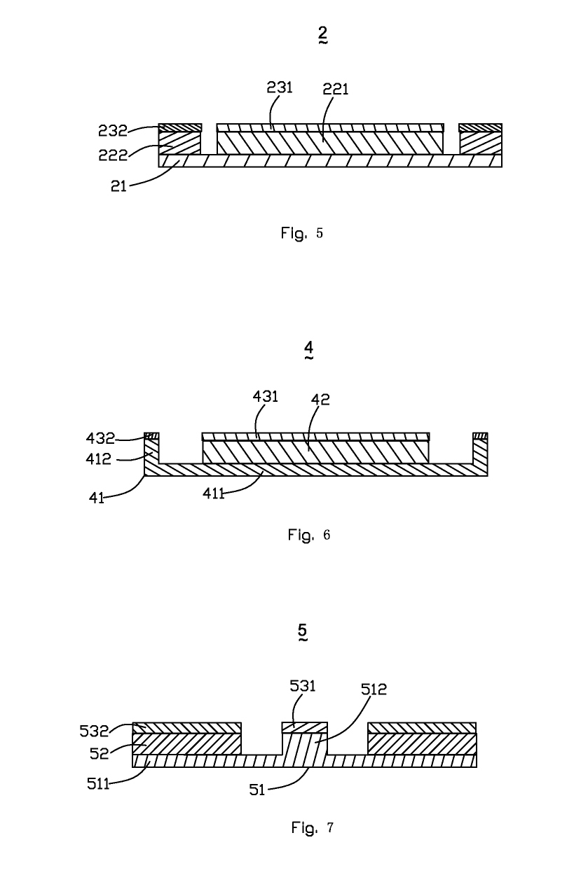

FIG. 5 illustrates the magnetic circuit unit 2 of the micro-speaker 10 in accordance with the first embodiment of the present disclosure, in which both the first magnetic conduction member 221 and the second magnetic conduction member 222 are permanent magnets. The second magnetic conduction member 222 may be a ring surrounding the first magnetic conduction member 221, or may be a plurality of separated pieces arranged around the first magnetic conduction member 221. The magnetic circuit unit 2 is used to provide a magnetic gap and to support the diaphragm, no matter how the first or second magnetic conduction member 221, 222 is configured.

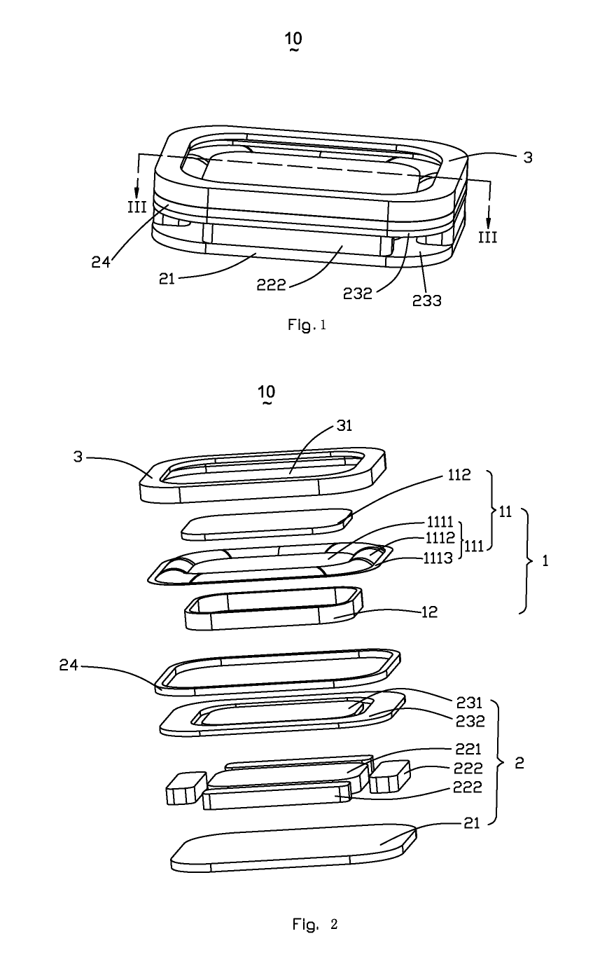

Referring to FIG. 6, a magnetic circuit unit 4 of a micro-speaker in accordance with a fourth embodiment of the present disclosure, includes a bowl-shaped yoke 41 with a bottom wall 411 and a sidewall 412 extending upwards from an edge of the bottom wall 411, a magnet 42 disposed within the yoke 41, an inner pole plate 431 attached on the magnet 42, and an outer pole plate 432 attached on a top face of the sidewall 412. The magnet 42 is a permanent magnet. In this embodiment, the diaphragm (shown in FIGS. 2-4) could be connected to the outer pole plate 432. And, for enlarging the vibration space of the diaphragm, the outer pole plate 432 is optionally higher than the inner pole plate 431. In an alternative embodiment, the outer pole plate is an optional element, and without the outer pole plate, the diaphragm could be positioned on the sidewall 412 directly.

Referring to FIG. 7, the magnetic circuit unit 5 of a fourth embodiment, includes a T-shaped yoke 51 including a bottom wall 511 and a side wall 512 extending upwards from an central portion of the bottom wall 511, a permanent magnet 52 attached to the bottom wall 511, an inner pole plate 531 attached to the side wall 512, and an outer pole plate 532 attached to a top face of the magnet 52. The magnet 52 may be a ring surrounding the side wall 512, or may be a plurality of separated pieces around the side wall 512, for providing a magnetic gap together with the side wall 512.

According to the embodiments described above, the position portion of diaphragm could be directly or indirectly connected to the outer pole plate with a top face of the outer pole plate higher than the inner pole plate. The position portion of diaphragm also could be indirectly connected to the outer pole plate via a gasket with a top face of the gasket higher than that of the inner pole plate. A greater space for vibration of the diaphragm is optional and preferable. A projection area of the diaphragm along the vibration direction on the bottom wall is not larger than the bottom wall, by which the micro-speaker is provided with smaller size, or is provided with enlarged magnetic circuit unit. Sound quality of the micro-speaker having such a configuration is accordingly improved.

The embodiments described above may be summarized as follows. A micro-speaker includes a magnetic circuit unit, a diaphragm connected to the magnetic circuit unit, and a voice coil connected to the diaphragm for driving the diaphragm to vibrate along a vibration direction. The magnetic circuit unit includes an inner part, an outer part, and a magnetic gap formed between the inner part and the outer part. The voice coil is partially received and capable of vibrating in the magnetic gap. One of the inner part and the outer part of the magnetic circuit unit is a magnet. An edge of the diaphragm is connected to the outer part of the magnetic circuit unit. By virtue of such a configuration, a projection of the diaphragm along the vibration direction on the magnetic circuit unit is located within the boundary of the magnetic circuit unit, thereby omitting a frame used in the elated art for supporting the diaphragm and the magnetic circuit unit. As the frame used in the related art is omitted by this disclosure, an outer side of the micro-speaker is formed by the outer part of the magnetic circuit unit and the edge of the diaphragm. For enlarging a vibration space of the diaphragm, the outer part is higher than the inner part, or the diaphragm connects to the outer part via a gasket attaching to the top of the outer part.

It will be understood that the above-mentioned particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A micro-speaker, comprising:
a vibrating unit, including a diaphragm and a voice coil driving the diaphragm to vibrate along a vibration direction, the diaphragm including a position portion serving as an edge of the diaphragm;
a magnetic circuit unit supporting the diaphragm, including a base board, a first magnetic conduction member disposed at a central portion of the base board, a second magnetic conduction member around the first magnetic conduction member, and a magnetic gap formed by the first and second magnetic conduction members;
a projection of the diaphragm along the vibration direction on the base board being within an outline of the base board.

2. The micro-speaker as claimed in claim 1 including a plurality of separated second magnetic conduction members, each two adjacent second magnetic conduction members forming a gap, the gap communicates with outside of the micro-speaker and serves as an air leaking hole.

3. The micro-speaker as claimed in claim 1, wherein the magnetic circuit unit includes a first pole plate attached on the first magnetic conduction member, and a second pole plate attached on the second magnetic conduction member.

4. The micro-speaker as claimed in claim 3, wherein the position portion of the diaphragm is directly positioned on the second pole plate.

5. The micro-speaker as claimed in claim 4, wherein a top face of the second pole plate is higher than that of the first pole plate.

6. The micro-speaker as claimed in claim 3 further including a gasket disposed between the position portion of the diaphragm and the second pole plate.

7. The micro-speaker as claimed in claim 6, wherein a top face of the gasket is higher than that of the first pole plate.

8. The micro-speaker as claimed in claim 1, wherein the second magnetic conduction member is ring-shaped.

9. A micro-speaker, comprising:
a vibrating unit, including a diaphragm and a voice coil driving the diaphragm to vibrate along a vibration direction, the diaphragm including a position portion serving as an edge of the diaphragm;
a magnetic circuit unit supporting the position portion of the diaphragm, including a bottom wall, and a magnetic gap for the voice coil partially inserting into; wherein
a projection area of the diaphragm along the vibration direction is not larger than an area of the bottom wall.

10. The micro-speaker as claimed in claim 9, wherein the magnetic circuit unit includes a yoke, a magnet attached to the yoke, an inner pole plate attached to one of the yoke and the magnet, and an outer pole plate attached to the other one of the yoke and magnet.

11. The micro-speaker as claimed in claim 10, wherein the yoke is bowl shaped or T-shaped.

12. The micro-speaker as claimed in claim 11, wherein the outer pole plate surrounds the inner pole plate and includes a top face higher than that of the inner pole plate.

13. The micro-speaker as claimed in claim 12, wherein the diaphragm is directly positioned to the outer pole plate.

14. The micro-speaker as claimed in claim 11, wherein a gasket is attached to the outer pole plate and includes a top face higher than that of the inner pole plate, and the diaphragm is positioned to the gasket.

15. A micro-speaker, comprising:
a magnetic circuit unit including an inner part, an outer part, and a magnetic gap formed between the inner part and the outer part, one of the inner part and the outer part including a magnet;
a diaphragm including an edge positioning on the outer part of the magnetic circuit unit;
a voice coil connecting the diaphragm for driving the diaphragm to vibrate along a vibration direction.

16. The micro-speaker as described in claim 14 further including a front cover pressing on the edge of the diaphragm to the outer part of the magnetic circuit unit.

17. The micro-speaker as described in claim 14 further including a gasket between the edge of the diaphragm and the outer part of the magnetic circuit unit, the gasket being higher than the inner part of the magnetic circuit unit.

18. The micro-speaker as described in claim 14, wherein the outer part is higher than the inner part.

19. The micro-speaker as described in claim 14 including an outer side formed by the outer part of the magnetic circuit unit and the edge of the diaphragm.
